(19) United States
(12) Patent Application Publication
(10) Pub. No.: US 2009/0208696 A1
(43) Pub. Date: Aug. 20, 2009

(54) Adjustable bush trimmings tarp

(76) Inventor: Dennis Keith Frommeyer, Sadieville, KY (US)

Correspondence Address: DENNIS KEITH FROMMEYER, 2800 JOSEPHINE RD., SADIEVILLE, KY, 40370, US

(21) Appl. No.: 12/034,652

(22) Filed: Feb. 20, 2008

(51) Int. Cl. B32B 3/06

(52) U.S. Cl. 428/98

(57) ABSTRACT

The Adjustable Bush Trimmings Tarp (10) is a tarp made up of six pieces of a heavy duty pliable material such as heavy cloth, canvas, or a polyethylene type material. The tarp (10) is positioned around a bush (7) or in front of a series of bushes (7), that are set in a bed of a decorative bedding material (9) such as rocks, stones, wood chips, etc. The tarp (10) covers the decorative material (9) in such a way, so that when the bush (7) or bushes (7) are trimmed, the trimmings (8) fall onto the tarp (10) instead falling onto or into the decorative bedding material (9). Then the tarp (10) is disconnected at one of the hook and loop fasteners and simply rolling up the tarp (10) with the trimmings (8) inside and disposing of the trimmings (8) by unrolling the tarp (10) in a refuse container, refuse bag, lawn cart, or wheelbarrel. Therefore, the tarp (10) saving valuable time and energy in the clean up of the trimmings (8), in which it is difficult to rake the trimmings (10) out of the decorative bedding material (9) and it is tedious and labor intensive to pick the trimmings (8) out by hand. The tarp (10) is adjustable by means of alternating which direction the sections (1) are put together. Example 1: all short-sides of sections pointing towards the bush will encircle the bush (7). Example 2: alternating short-side with long-side will make a straight line. The user can alternate the sections (1) in many different configurations.

### CROSS-REFERENCE TO RELATED APPLICATIONS

Not Applicable

### FEDERALLY SPONSORED RESEARCH

Not Applicable

### BACKGROUND OF INVENTION

1. Field of Invention

The invention relates to landscaping and lawn maintenance, more specifically to catching the trimmings when trimming a bush or a series of bushes that is set in a bed of decorative bedding material such as rocks, stone, or wood chips, also being adjustable from being positioned around a bush, to halfway around a bush, to straight in front of series of bushes, to many other configurations depending on the situation.

2. Prior Art

In the past it has been a problem and an undesirable job to have to pick up the trimmings of a bush or a series of bushes that are set in decorative bedding material such as rocks, stone, or wood chips, after trimming them.

A bed of decorative bedding material such as rocks, stones, or wood chips set about a bush or a series of bushes is both functional and aesthetic. The bed is functional because it helps to minimize the growth of weeds and grass around the bush or bushes, it also helps to hold the moisture in the ground under the bush or bushes. The bed is considered to be aesthetic by the way it dresses up the area around the bush or bushes. The bed causes problems when the bush or bushes are to be trimmed, leaves, twigs, and small branches fall onto and into the rocks, stones, or wood chips. Raking the trimmings out of the bed is difficult because you cannot get the trimmings out without disturbing the bed of decorative bedding material. Picking the trimmings out by hand is even more difficult and time consuming and sometimes painful due to there sometimes being thorns from the bush mixed in with the trimmings. Leaving the trimmings where they fall detracts from the aesthetic quality of the bed.

There have been other tools invented to help with this problem, but they tend to be cumbersome, bulky and sometimes difficult to use. Most of these tools have some type of stiffener in the design, making it difficult for them to conform to the ground around the bush or bushes. The current invention has no stiffeners, so to allow the tarp to conform to the ground. Prior tools are also designed to do only one bush at a time, whereas the current invention can do one bush or a series of bushes. Using the Adjustable Bush Trimmings Tarp will eliminate hours of tedious clean up, and keep all decorative bedding used around bush or bushes well groomed with minimal work.

### SUMMARY OF THE INVENTION

The object of the invention is to provide an adjustable means of putting a specially or uniquely made tarp around a bush or in front of series bushes to be trimmed. Said tarp is to be made of heavy duty pliable material such as heavy cloth, canvas, or a polyethylene type material. The tarp is to consist of six sections made in the shape of a trapezoid. Each section to be held together with hook and loop type fasteners, which will allow the tarp to be readily positioned around a bush and also be adjustable to be positioned in a straight line in front of a series of bushes. The tarp can also be adjusted in other configurations depending on which sides are positioned together. The user can use any or all six sections depending on the configuration needed.

Positioning the Adjustable Bush Trimmings Tarp around the bush or bushes will allow for the trimmings to fall onto the tarp, instead of onto or into the decorative bedding material around the bush or bushes, then rolled up with the trimmings in the tarp for easy clean up and then simply unrolling the tarp in a large refuse container, large refuse bag, lawn cart, or wheel-barrel for easy disposal.

### BRIEF DESCRIPTION OF THE DRAWINGS

FIG. 1 is a top view of one of the sections of tarp. The tarp consists of six sections of this design, with each section being of a trapezoid shape, and of equal size. The hook portion of the hook and loop fastener is on the top side, both angled edges.

FIG. 2 is an underside view of one of the six sections as in FIG. 1. The difference being that the hem is on the underside and the loop portion of the hook and loop fastener is on the underside and along both angled edges.

FIG. 3 is a perspective view of the Adjustable Bush Trimmings Tarp positioned around the base of a bush using all six sections.

FIG. 4 is a perspective view of the Adjustable Bush Trimmings Tarp positioned around the base of a bush and the bush has been trimmed. The view shows the trimmings laying on the tarp.

FIG. 5 is a perspective view of the Adjustable Bush Trimmings Tarp after the bush has been trimmed. The tarp has been disconnected at one of the hook and loop fasteners and is being rolled up to facilitate the clean up of the trimmings.

FIG. 6 is a perspective view of the Adjustable Bush Trimmings Tarp positioned in front of a line of bushes in front of a wall. The bushes have been trimmed and the trimmings are laying on the tarp.

FIG. 7 is a perspective view of the Adjustable Bush Trimmings Tarp positioned encircling half of a bush. The bush has been trimmed and the trimmings are laying on the tarp.

FIG. 8 is a perspective view of the Adjustable Bush Trimmings Tarp showing a different configuration, to show the many different configurations that can be made.

### DRAWINGS—REFERENCE NUMERALS

1 one section of the tarp (top side)
2 one section of the tarp (under side)
3 angled edge left side
4 angled edge right side
5 hook side of the hook and loop fastener
6 loop side of the hook and loop fastener
7 bush
8 trimmings (twigs,leaves,small branches)
9 decorative bedding material (rocks, stones, wood chips, etc.)
10 Adjustable Bush Trimmings Tarp

### DESCRIPTION OF THE PREFERRED EMBODIMENT

For the purposes of promoting and understanding the principles of the invention, reference will now be made to the embodiment illustrated in the drawings and specific language will be used to describe the same. The embodiments disclosed below are not intended to be exhaustive or limit the invention to the precise forms disclosed in the following detailed description. Rather, the embodiments are chosen and described so that others skilled in the art may utilize the invention.

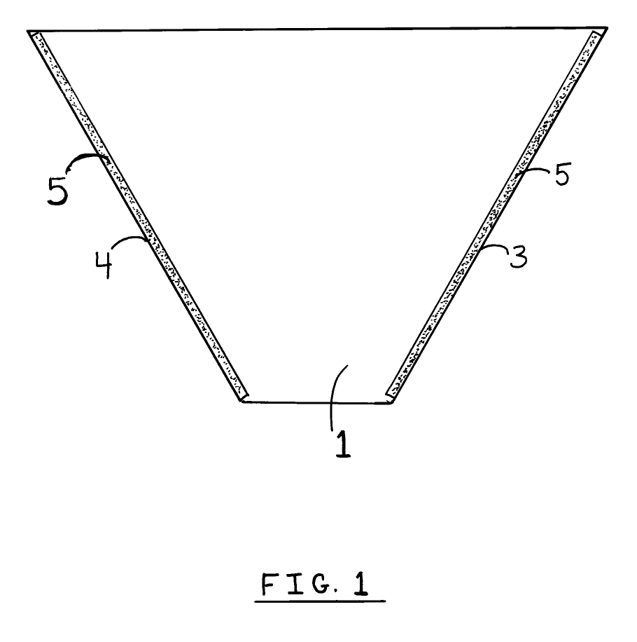

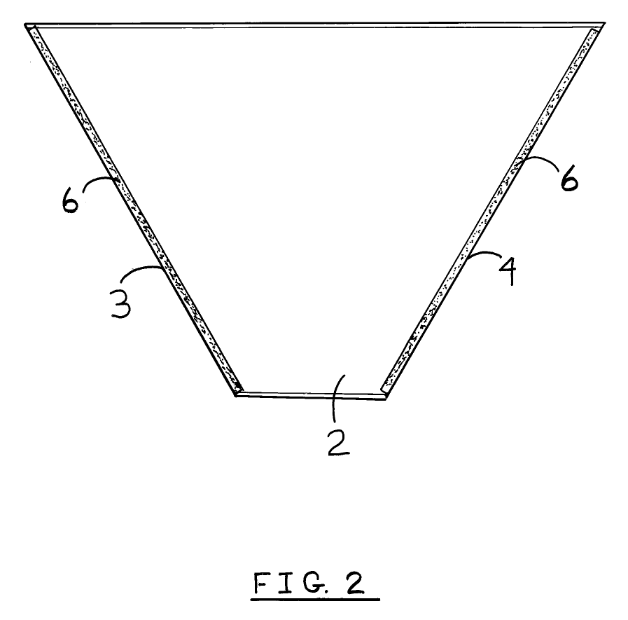

Referring to FIG. 1 (top view) and FIG. 2 (underside view) the trimmings tarp 10 consists of six sections I and 2 of this design, with each section of a trapezoid shape, and of equal size. The angle of the edges 3 and 4 to be 60 degrees. Each section 1 and 2 to be made of a heavy duty pliable material such as heavy cloth, canvas, or a polyethylene type material. Each section 1 and 2 to be hemmed on all edges to prevent unraveling of the material used. Then a hook and loop type fastener to be attached to edges 3 and 4 with the hook 5 side attached on side 1 and the loop 6 side being attached on side 2 along edges 3 and 4.

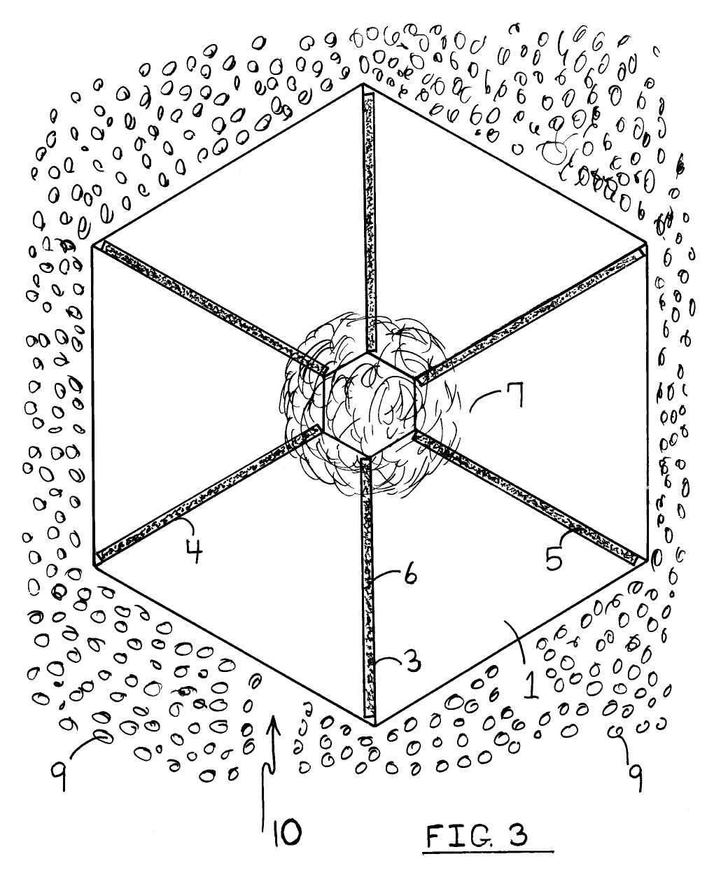

Referring to FIG. 3 the trimmings tarp 10 is positioned around a bush 7 by connecting each section 1 together with the hook 5 and loop 6 fasteners along edges 3 and 4.

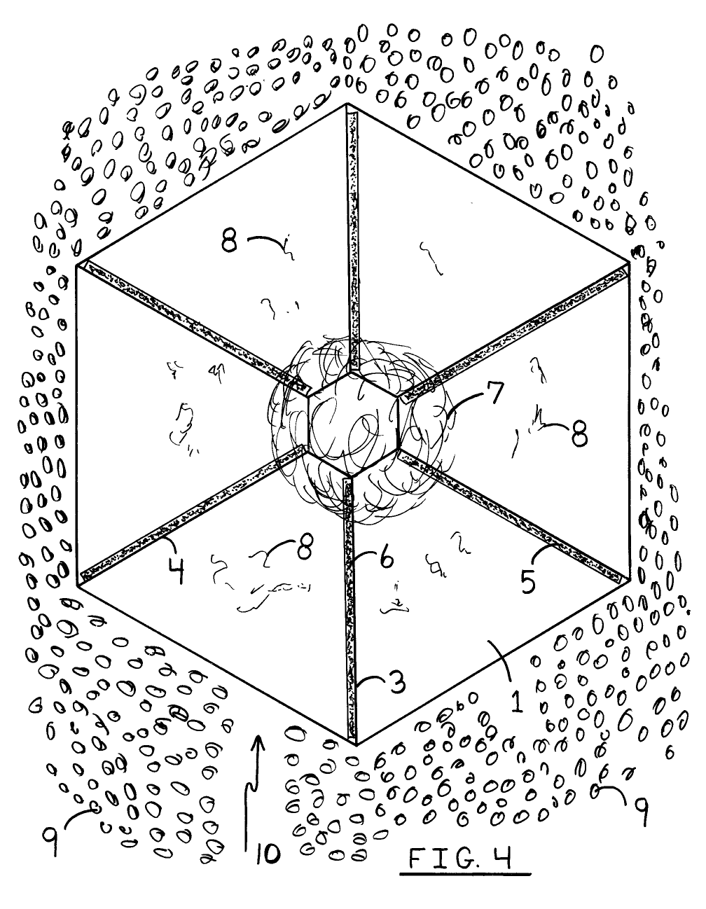

Referring to FIG. 4 the adjustable bush trimmings tarp 10 of FIG. 3, having been positioned around bush 7 and the bush having been trimmed and the trimmings 8 (leaves, twigs, little branches) laying on the tarp 10, preventing said trimmings 8 from falling onto and into the decorative bedding material 9 such as rocks, stones, wood chips, etc.

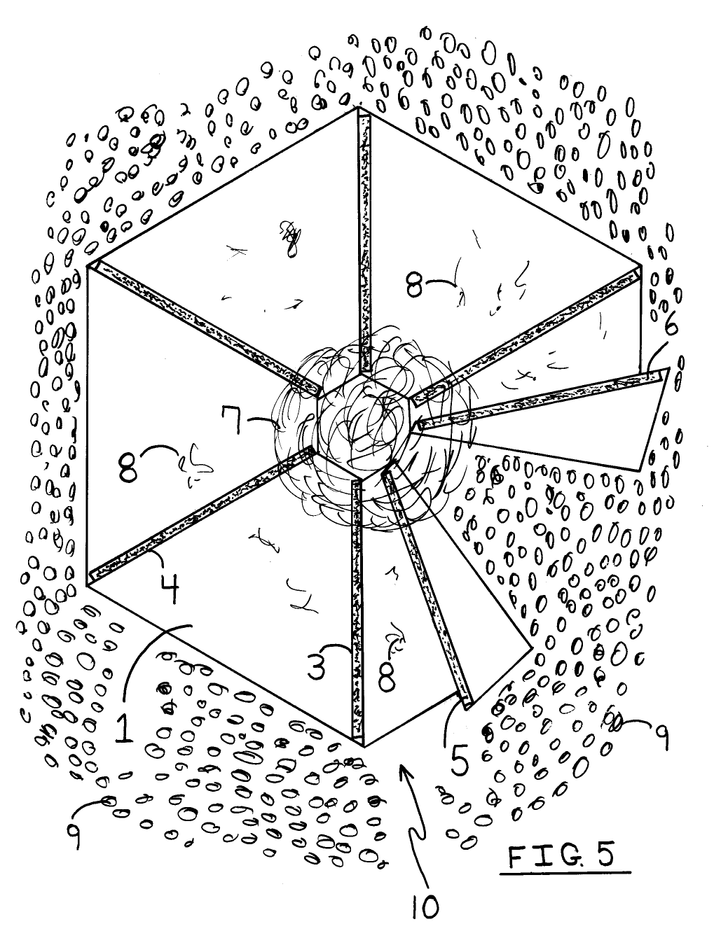

Referring to FIG. 5 the adjustable bush trimming tarp 10 is disconnected at one of the hook 5 and loop 6 fasteners. Then simply roll up the tarp 10 for easy clean up of the trimmings 8. Therefore keeping the trimmings 8 out of the decorative bedding material 9. With no raking involved. Disposing of the trimmings 8 by unrolling the tarp 10 into a large refuse container, large refuse bag, lawn cart, or a wheelbarrel.

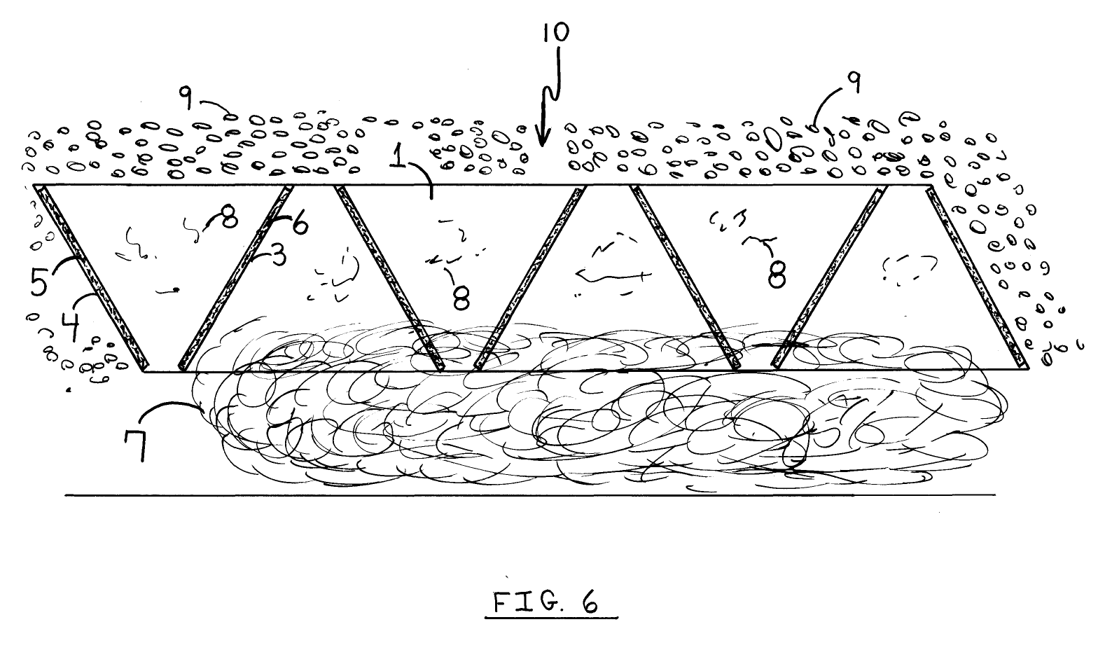

Referring to FIG. 6 the adjustable bush trimmings tarp 10 can also be assembled in a straight line by simply alternating each section 1 of the tarp 10, short side, long side, short side, etc. and connecting with the hook 5 and loop 6 fasteners. Trimming the bushes 7 and picking up the trimmings 8 by rolling up the tarp 10.

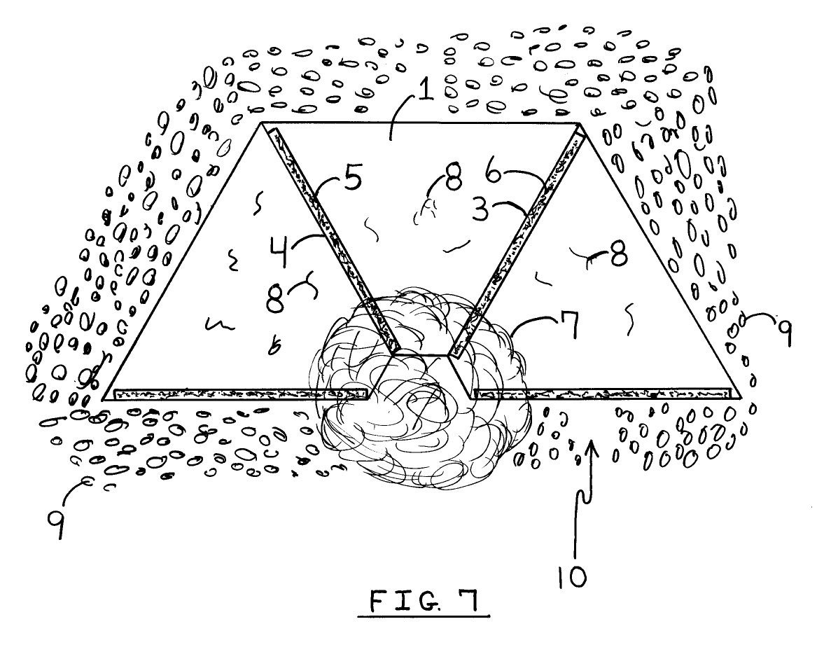

Referring to FIG. 7 the adjustable bush trimmings tarp 10 being positioned around half of a bush 7, to show if there is something behind the bush 7 to prevent the tarp 10 from going all the way around the bush 7.

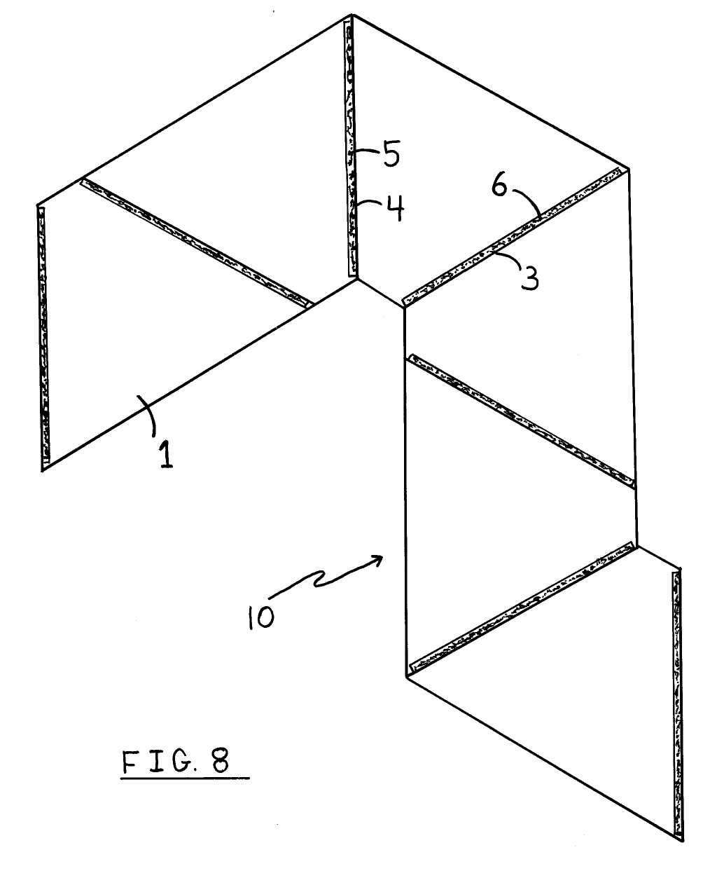

Referring to FIG. 8 the adjustable bush trimmings tarp 10 being positioned in a different configuration, as to show the many different configurations the adjustable bush trimmings tarp 10 can be positioned.

I claim:

1. An adjustable bush trimmings tarp for catching of and the removal of the trimmings from when a bush or a set of bushes are trimmed, comprising of one to six sections of a tarp being placed under and in front of said bush or bushes. Said sections are in equal size and in the shape of a trapezoid. Said sections to be connected by a hook and loop type fastener. Said sections to be made of a heavy duty pliable material such as heavy cloth, canvas, or a polyethylene type material, as to allow material to conform to the ground around the bush or bushes. Sections are placed in such a manner as to allow the trimmings to fall onto the tarp, therefore keeping the trimmings from falling onto and into the decorative bedding material around the bush or bushes. Decorative bedding material consisting of rocks, stone, wood chips, etc.. Also allowing for easy clean up by disconnecting tarp at one of the hook and loop fasteners and rolling up said tarp with trimmings inside and disposing of the trimmings by unrolling said tarp in a refuse container, refuse bag, lawn cart, or wheelbarrel.

2. The adjustable bush trimmings tarp of claim 1, where in being adjustable by means of connecting said sections so as the short-side of said sections are pointing towards the bush, therefore by placing all six sections in this manner will completely encircle the bush.

3. The adjustable bush trimmings tarp of claim 1, where in being adjustable by means of connecting said section in a manner of alternating short-side with long-side, therefore forming a straight line with said tarp.

4. The adjustable bush trimmings tarp of claim 1, where in being adjustable by means of connecting said sections in a manner of alternating short-side, short-side, long-side, long-side or long-side, long-side, short-side, short-side, or any combination there of, so as to make many different configurations.

5. The adjustable bush trimmings tarp of claim 1 having all edges hemmed to prevent unraveling or fraying of material.

6. The adjustable bush trimmings tarp of claim 1, may also be used for in other purposes for which the tarp may be adapted for.
